(19) United States
(12) Patent Application Publication
(10) Pub. No.: US 2023/0082188 A1
(43) Pub. Date: Mar. 16, 2023

(54) SMART TRIGGER INITIATED OR EXTENDED COLLABORATION PLATFORM

(71) Applicant: WAAGU INC., Cupertino, CA (US)

(72) Inventors: VENKATA T. GOBBURU, Cupertino, CA (US); NAGESH CHALLA, Cupertino, CA (US)

(21) Appl. No.: 17/733,890

(22) Filed: Apr. 29, 2022

Related U.S. Application Data
(63) Continuation-in-part of application No. PCT/US20/58065, filed on Oct. 29, 2020.
(60) Provisional application No. 62/927,636, filed on Oct. 29, 2019.

(51) Int. Cl. H04L 65/1069; G06K 7/14; G06K 7/10; G06Q 30/00

(52) U.S. Cl. CPC H04L 65/1069; G06K 7/1413; G06K 7/1417; G06K 7/10297; G06Q 30/016

(57) ABSTRACT

A real-time-communication (RTC) collaboration platform allows for customer-initiated and/or agent-initiated RTC collaboration sessions that may include rich media (voice, video, screen shares, annotations, drawings, document sharing and editing, etc.). The collaboration session may be initiated in various embodiments, by a smart trigger including one or more links that may be selected as a trigger. When the link(s) are selected session information may be transmitted or otherwise elected to target the session. In some embodiments, a combination of smart trigger devices may provide additional benefits, such as restricting the initiation of a session to a location where the NFC tag is present. Although individual examples provided herein describe the smart trigger as a QR code, an NFC tag, and/or a link on a web page, smart triggers of any type may be used to initiate a communication session as described herein. A smart trigger may also be used to extend the collaboration session to a new device.

### CROSS-REFERENCE TO RELATED APPLICATIONS

This application claims the benefit of U.S. provisional application No. 62/927,636 entitled “Smart Trigger initiated Collaboration Platform” and filed on 29 Oct. 2019, which is incorporated by reference as though fully set forth herein. This application also is a continuation in part of PCT/US2020/058065 entitled “Smart Trigger Initiated Collaboration Platform” and filed on 29 Oct. 2020, which is also incorporated by reference as though fully set forth herein.

### BACKGROUND

### a. Field

The present disclosure relates to rich media communications sessions that may be initiated through the use of a smart trigger, such as a QR code, NFC tag, RFID tag or other link.

### b. Background

Typical customer service calls are initiated by a telephone call in which a customer dials a customer service telephone number and a call agent retrieves information from the customer to determine how to proceed with the customer call. A customer, for example, may have to provide an account number, password, and general information about the purpose of the call (product information, etc.).

### BRIEF SUMMARY

In various embodiments, a real-time-communication (RTC) collaboration platform allows for a collaboration session. A collaboration session comprises a communication session that may include rich media (e.g., voice, video, screen shares, annotations, drawings, document sharing and editing, etc.). An example of a collaboration session includes, but is not limited to, a customer-initiated and/or agent-initiated RTC communication session that includes rich media (voice, video, screen shares, annotations, drawings, document sharing and editing, etc.). The collaboration session may be initiated and/or extended in various embodiments, by a smart trigger including one or more links that may be selected as a trigger. The “smart trigger,” for example, may comprise at least one trigger, such as but not limited to a QR code, a barcode, an NFC tag, RFID tag or the like that is adapted to provide the one or more links when activated (e.g., by scanning with a camera or NFC or RFID receiver or a dedicated application to work with the camera). The smart trigger, for example, may comprise a QR code that is adapted to identify a purpose associated with a collaboration session, such as a product or service identifier. Thus, when the link(s) are selected session information may be transmitted or otherwise elected to target the session. In some embodiments, a combination of smart trigger devices (e.g., a QR code and NFC tag) may provide additional benefits, such as restricting the initiation of a session to a location where the NFC tag is present. Although individual examples provided herein describe the smart trigger as a QR code and/or an NFC tag, smart triggers of any type may be used to initiate a communication session as described herein.

Once initiated, the collaboration session may provide options for the customer to elect to enable various features of the session (e.g., allow access to microphone, camera, location, identity, etc.). The smart trigger (e.g., QR code or NFC tag) may provide information to quickly and accurately direct the session to an agent able to assist the customer. The smart trigger, for example, may be associated with a product (e.g., a QR code printed on a label of a product) and identify the exact make and model of the product to assist in a product-related customer-service session. In this particular example, a customer may initiate the session simply by scanning the QR code on the product to initiate the call. Once the session has been established, rich media options can allow the agent to determine detailed information from the customer about the product and assist in streamlining the communication session.

In other implementations, a smart trigger may be placed in any manner to provide an opportunity to initiate a communication session. A smart trigger, for example, may be placed or printed on a product as described, may be retroactively applied to a product for supplemental assistance, may be applied to equipment or locations (e.g., to equipment or entrances to rental property such as vacation or property rental, rental equipment, rental vehicles or the like). Smart triggers may also be associated with services such as insurance policies, roadside assistance, or the like, where the smart trigger may accurately and quickly connect a user to a customer service agent and accurately convey any identifying information to the agent to quickly establish a meaningful communications session.

In some embodiments, an RTC communication session may be initiated directly via a smart trigger (e.g., QR code and/or NFC tag) by the customer as opposed to an agent starting a rich session as a follow-on step in a regular phone call. The smart trigger can help save agent time and effort related to gathering details pertaining to the issue, it can also help with the accuracy of the information being provided by the customer (“What is the model number?” or “Can you tell me the policy number?” etc.) because these can be encoded directly into the QR code. The customer doesn't have to hunt for this information—e.g. the model number might be in a very awkward location, etc.). Smart triggers can also help the agent understand what capability is reasonably available from the customer else the agent has to query “do you have a mobile phone?” Is it a feature phone or a smart phone? Etc.? Use of a smart trigger can also help preserve anonymity such as in a vacation or property rental scenario, the renter on scanning the QR code is directly connected to the owner or designated support person without having to provide actual contact information. A smart trigger can also help with cost, such as in a vacation of property rental scenario, the renter might roaming and be faced with expensive international calls in trying to reach the owner's mobile phone number. The QR code can directly connect over an IP connection. By using dynamic smart triggers (e.g., dynamic QR codes), the triggered behavior can be modified. For example, if rental equipment has been upgraded, without printing new QR codes for the rental property, the agent can be pointed to the specifications for the new equipment (e.g., washer).

In one particular embodiment, an agent waiting room is provided. A “waiting room”, a web page where the available agents are logged in and can answer the requests as they come in, provides a method to match up customers and service agents. An analogy is a cab dispatcher announcement and the first willing cabbie can take the request. The cab driver who has taken the session then doesn't get another call until he “is ready & comes back”.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a block diagram of an example RTC collaboration system architecture.

FIG. 2 is a block diagram of another example RTC collaboration system architecture.

FIG. 3 is a flowchart of an example method of establishing a real-time communication (RTC) collaboration session.

FIG. 4 is a schematic diagram showing an example integrated system architecture for a collaboration platform.

FIG. 5 is a schematic diagram showing an example distributed system architecture for a collaboration platform.

FIG. 6 shows an example collaboration platform backend including a sign in page, a customer account creation page and a delegated customer account management page.

FIG. 7 further shows an example customer account management page that includes customer settings.

FIG. 8 is a screen shot of an embodiment of a session in which an additional device may be added via one or more smart triggers displayed or otherwise available during the session.

FIG. 9 is a screen shot of an embodiment of a session in which an additional device may be added via selection of an option to display or otherwise make available a smart trigger during the session.

### DETAILED DESCRIPTION

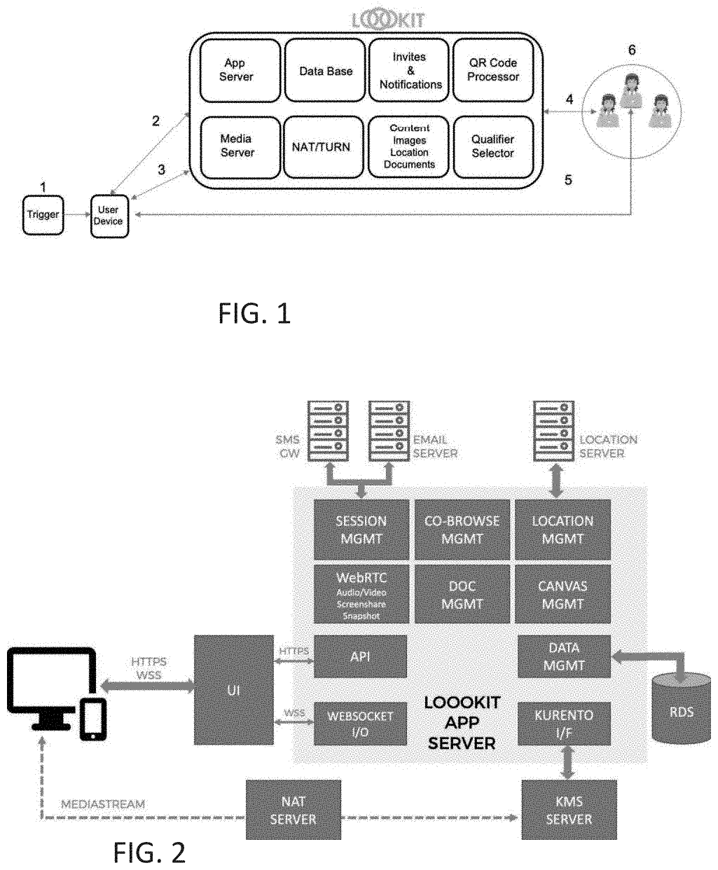

FIG. 1 is a block diagram of an example RTC collaboration system architecture. In this embodiment, a smart trigger 1 can be a smart trigger that includes one or more links and is adapted to provide the one or more links when activated. The smart trigger may, for example, comprises at least one trigger, such as but not limited to a QR code, a barcode, an NFC tag, an RFID tag, a link on a web page, or the like. The smart trigger may be activated to provide the one or more link, such as by scanning with a camera or NFC or RFID receiver or a dedicated application to work with a camera or other communication device adapted to communicate with an NFC or RFID receiver. The smart trigger 1, for example, may comprise a QR code that is adapted to identify a purpose associated with a collaboration session, such as a product or service identifier. Thus, when the link(s) are selected, session information may be transmitted or otherwise elected to target the session. In some embodiments, a combination of smart trigger devices (e.g., a QR code and NFC tag) may provide additional benefits, such as restricting the initiation of a session to a location where the NFC tag is present. Although individual examples provided herein describe the smart trigger as a QR code and/or an NFC tag, smart triggers of any type may be used to initiate a communication session as described herein.

Once initiated, the collaboration session may provide options for the customer to elect to enable various features of the session (e.g., allow access to microphone, camera, location, identity, etc.). The smart trigger (e.g., QR code or NFC tag) may provide information to quickly and accurately direct the session to an agent able to assist the customer. The smart trigger, for example, may be associated with a product (e.g., a QR code printed on a label of a product) and identify the exact make and model of the product to assist in a product-related customer-service session. In this particular example, a customer may initiate the session simply by scanning the QR code on the product to initiate the call. Once the session has been established, rich media options can allow the agent to determine detailed information from the customer about the product and assist in streamlining the communication session.

In other implementations, a smart trigger 1 may be placed in any manner to provide an opportunity to initiate a communication session. A smart trigger 1, for example, may be placed or printed on a product as described, may be retroactively applied to a product for supplemental assistance, may be applied to equipment or locations (e.g., to equipment or entrances to rental property such as vacation or property rental, rental equipment, rental vehicles or the like). Smart triggers 1 may also be associated with services such as insurance policies, roadside assistance, or the like, where the smart trigger may accurately and quickly connect a user to a customer service agent and accurately convey any identifying information to the agent to quickly establish a meaningful communications session.

In some embodiments, an RTC communication session may be initiated directly via a smart trigger 1 (e.g., QR code and/or NFC tag) by the customer as opposed to an agent starting a rich session as a follow-on step in a regular phone call. The smart trigger 1 can help save the agent time and effort related to gathering details pertaining to the issue, it can also help with the accuracy of the information being provided by the customer (“What is the model number?” or “Can you tell me the policy number?” etc.) because these can be encoded directly into the smart trigger 1 (e.g., QR code). The customer doesn't have to hunt for this information—e.g. the model number might be in a very awkward location, etc.). Smart triggers 1 can also help the agent understand what capability is reasonably available from the customer else the agent has to query “do you have a mobile phone?” Is it a feature phone or a smart phone? Etc.? Use of a smart trigger 1 can also help preserve anonymity such as in a vacation or property rental scenario, the renter on scanning the QR code is directly connected to the owner or designated support person without having to provide actual contact information. A smart trigger 1 can also help with cost, such as in a vacation of property rental scenario, the renter might be roaming and be faced with expensive international calls in trying to reach the owner's mobile phone number. The QR code can directly connect over an IP connection. By using dynamic smart triggers 1 (e.g., dynamic QR codes), the triggered behavior can be modified. For example, if rental equipment has been upgraded, without printing new QR codes for the rental property, the agent can be pointed to the specifications for the new equipment (e.g., washer).

In one particular embodiment, an agent waiting room is provided. A “waiting room”, a web page where the available agents are logged in and can answer the requests as they come in, provides a method to match up customers and service agents. An analogy is a cab dispatcher announcement and the first willing cabbie can take the request. The cab driver who has taken the session then doesn't get another call until he “is ready & comes back”.

A user device is adapted to read or otherwise access the smart trigger 1, such as via a camera or wireless communication device of the user device. The user device, for example, may comprise a smartphone, tablet, laptop or other portable electronic device adapted to read or otherwise access the smart trigger 1.

In the example shown in FIG. 1, for example, the user device accesses the smart trigger 1, which provides a link to the user device. The user device uses the link and accesses a web page via a browser of the user device. A server, such as the application server and/or media server shown in FIG. 1, may host the web page and one or more applications and/or media associated with the web page designated by the link associated with the smart trigger. The application server, for example, may comprise a user interface (UI), application programming interface (API), web socket and session management for an RTC collaboration session to be established via the one or more links provided by the smart trigger.

A user interface (UI), for example, may comprise a front-end application to access an RTC collaboration session service. In one example, the UI is built using an HTML/CSS and ReactJS framework, although that is only one example implementation. The application can interact with an API component of the system (e.g., an application server) using REST APIs. It can also maintain a bidirectional websocket connection with the system (e.g., application server). Media can be streamed by a media server, such as but not limited to a Kurento Media Server.

A network address translation (NAT) server can be used to map the link to the one or more servers hosting the web page on the browser of the user device via communication session 2. The NAT server, for example, may use a protocol such as Traversal Using Relays around NAT (TURN) to assist in the traversal of a network address translator (NAT) or firewalls for multimedia applications and may be used with Transmission Control Protocol (TCP) and User Datagram Protocol (UDP). Other address translation servers and/or protocols may be used in various embodiments, however.

A service may use one or more qualifiers to increase the efficiency of the session 3. The qualifier(s), for example, may be used to connect a user to one or more specific agent with specific relevance to a subject matter of the session identified via the smart trigger 1. The service may provide information directly to the connected agent or allow the agent to be able to bring up information (e.g., background information) to allow the experience to be tailored to fit the subject matter of the session and/or to tailor the experience to interact seamlessly with the particular user device used by the user in the session. Qualifier(s) can be user selections, information entered by a user into the web page, information identified by the smart trigger, or provided by the user device in establishing the communication session. Qualifier(s) could also be system generated information, such as date/time, location (e.g., when enabled), type of browser, or other information helpful to establish and maintain the communication session. Examples of qualifiers include a preferred language, a department name, a preferred agent or group identifier, a preferred agent or group name, a specific service required by the user, a customer contact information such as a phone number, user name or the like, a time of day, a type of browser or other application being used in the session, etc. In another example, a user or agent may enter a passcode (e.g., a numerical PIN, an alphanumeric password, identification of one or more images, or other identifier) to enter a session. The passcode, for example, may be identified as a qualifier, may be entered by the user and/or agent to identify the party, such as to provide authentication for the collaboration session.

Based on one or more qualifiers (whether selected by the user and/or provided as part of establishing the communication session), an agent or group of agents that meets the attributes for the session is notified in communication 4. An agent meeting those attributes connects with the user on the web page and can start any of a plurality of available modes of communication/collaboration, such as but not limited to messaging, chat, audio, video, screen share, co-browse, white board, etc. in communication 5. As shown in FIG. 1, the agent(s) may be part of a call center 6 or other group of available agents meeting the attributes associated with the session.

The communication session may be established for any number of applications. For example, a smart trigger such as a QR code or barcode may be printed on a business card of a salesperson or other service provider such as a service technician, doctor office, accountant office, etc. When the trigger is scanned, a permission request is triggered to the user for sending a message to a contact. The contact receives a notification and can immediately connect with the user in a communication session.

In another example, a trigger can be in the form of a web link and stored in an address book of a user device (e.g., phone, PC, tablet, etc.). When a contact is to be made, the user selects the link and is taken to a web page on the device browser. Alternately, the user may give permission for their phone number or other communication identifier to be used for a notification to the contact.

The contacted person may receive a notification, such as an SMS, email, social media notification, etc.) that the user wants to communicate. An RTC collaboration session can then ensue, or any other mode supported by the service can be activated, such as via an invite and notification application. If the contact is unable to enter a communication session at that time, a calendaring function can be set up for a later time that is available. In that case, the user will receive a calendar invitation in a compatible format that is embedded in both the user and the contact person's respective calendars. At the scheduled time, both the user and the contact can receive notifications with an embedded link of the session that they can join.

A smart trigger, for example, can be used to trigger a session with a specific agent. The smart trigger, in one example, can be adapted to trigger an outgoing SMS to a hosting server (e.g., an application server and/or media server). The server can extract a caller ID associated with a sending user device (e.g., smartphone) and query a database. If it encounters a match, it accesses a user profile and can send a notification to an agent that has served the user previously and/or that can provide relevant support.

FIG. 2 is a block diagram of another example RTC collaboration system architecture. In this embodiment, for example, the system comprises a user device, such as but not limited to a smartphone, a tablet, a PC, a laptop, etc.) adapted to establish a communication session with one or more application server of the system via a user interface (UI), such as via an HTTP, HTTPS, and/or Web Socket protocol, such as shown in FIG. 2. In this embodiment, for example, the user interface (UI) may be accessed via a browser of the user device.

The application server, for example, may include a session management module adapted to provide invites and/or notifications to one or more participants in the session. The invites and/or notifications, for example, may be served by an SMS gateway via SMS message, an email server, or the like. A Web real-time communication (WebRTC) module is adapted to provide web browsers and mobile applications on the user device with real-time communication, such as via simple application programming interfaces (APIs) and allow audio and/or video communication to work inside web pages by allowing peer-to-peer communication without requiring plugins or having to download native apps.

In one example, the application server may support WebRTC based video conferencing and screen sharing along with whiteboard related actions. The server may comprise a headless server to be used to host communication via user chat, whiteboard, video conference, screen-share, and the like within a session. The server can communicate, in one example, via secure REST APIs and Websockets.

An API may provide a primary interface for communication, authentication and authorization, request validation, and the like. Examples of APIs include login, create session, start session, login-customer, end session, invite user, upload file document, download file, logout.

Websocket communication can be used to provide a connection with participants, transient data for communications, transient data for participants, user action in a session, session wide broadcasts, whiteboard actions in session, WebRTC actions in session, and other functions.

A co-browse management module provides the ability for the parties in the session to view and interact/navigate in a shared web page field accessible and operable between the two parties.

Content, images, information, and the like can be provided by one or more of a document management module, a location management module, a canvas management module. A document management module, for example, may provide editing and formatting of documents for presentation in the session (e.g., conversion from word to PDF or the like). A location module may function to provide location services, such as with a location server, to provide location information for one or more of the parties, mapping functionalities, or the like. A canvas module may provide whiteboard or other interactive services that may support text, drawing, image, cutting, pasting, and other interactions within the session.

A data management module is adapted to access a database. The data management module can provide database interaction and persistent data validation and sanitization. A database may be used for persistent storage. User and session information may be maintained in the database for the duration of a session, and in some examples, may not persist any session of user information after a successful termination of the session. Other information such as document audit information, billing information, agent and customer related information (e.g., contact information, attributes associated with one or more user or agent to assist in matching the correct agent(s) to a user), and other information, on the other hand, may be kept as a persistent record in the database.

A media server, such as the Kurento Media Server (KMS) shown, is adapted to interface with the application server via an interface such as a Kurento interface, and establish a mediastream or other communication session with the user device via a server such as the NAT server shown. Services, for example, may include media pipeline, create and release, WebRTC endpoint, recorder endpoint, events for media server status, candidates gathered, as well as other functions.

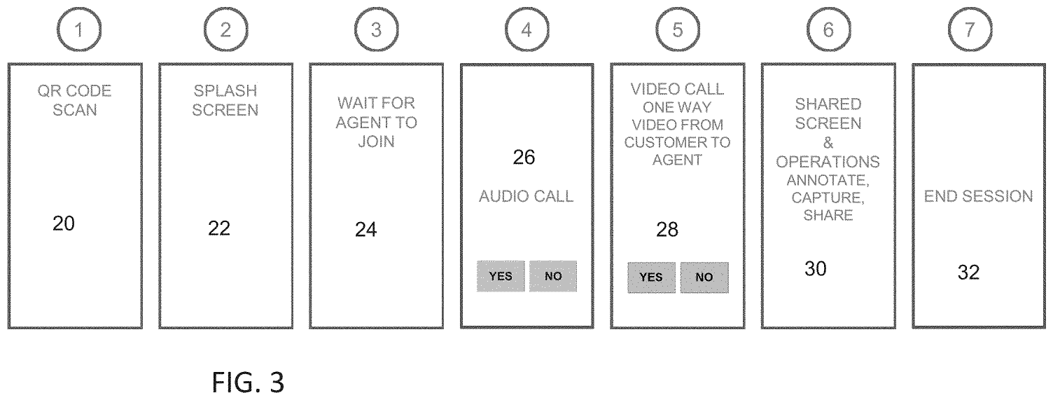

FIG. 3 is a flowchart of an example method of establishing a real-time communication (RTC) collaboration session. In this example, a QR scan or other smart trigger activation is performed in operation 20. As described above, this may be performed such as using a camera of a user device or other communication device (e.g., an NFC or RFID communication receiver) and retrieving information such as at least one link (e.g., a URL), and possibly context information for the communication session that may be transmitted and used to establish the communication session without downloading or installing any software (e.g., apps) to enable the communication session from the smart trigger. The link may be used to access the communication session such as through a browser or application.

The customer device (e.g., smartphone) may prompt the customer whether to proceed with the communication session upon scanning the QR-code. If elected, the customer device may provide a splash screen at 22 such as identifying the company, logo, product, service or the like associated with the communications session, such as to confirm the identity of the entity represented by the agent to the customer. The customer may provide further information such as a preferred language and elect to allow access to location data so that a customer-service agent may be selected.

The communications session can be adapted to wait for an agent to join at 24. The agent may receive an invitation, such as via a text message, email, chat, calendar reminder or invite, or other communication platform, and respond (e.g., click on a link in the invitation) to accept the invitation. The agent can initiate an audio and/or video and other rich communication session features.

When the parties are connected, the customer and/or the agent can be prompted to allow access to various features of the customer and/or agent device (e.g., microphone for an audio call 26, camera for a video call 28, shared screen and RTC communications options 30) through which the customer and agent may complete a rich media customer service session until an end 32. Operation 30 shows a shared screen accessible between the parties that may be modified or controlled by one or both of the parties. The shared screen, for example, may provide access to operations, annotations, capture, sharing, and the like.

In various embodiments, different RTC options may be provided, such as but not limited to audio/video call, screen annotations, capture, audio, video, location, screen capture, PDF documents, canvas drawings, image capture, etc.).

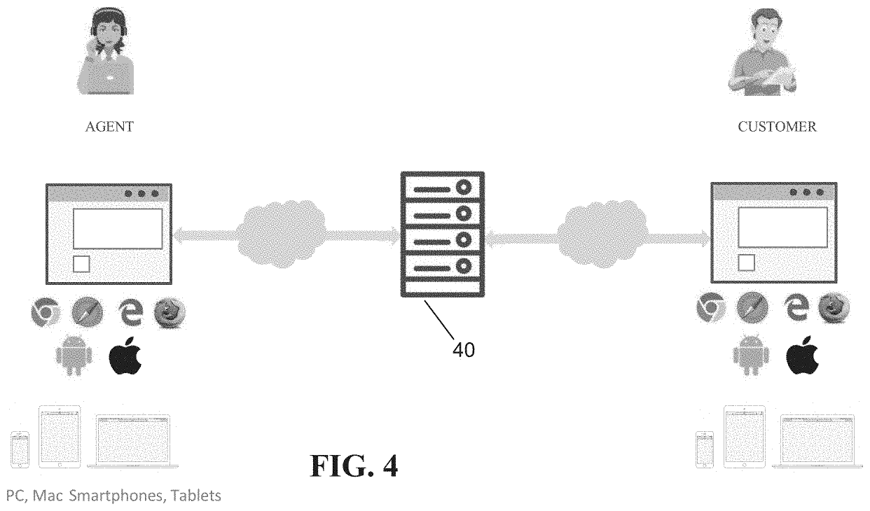

FIG. 4 is a schematic diagram showing an example integrated system architecture for a collaboration platform. In this particular embodiment, for example, the system architecture enables a customer on a mobile connected device, such as a Smartphone, or a Tablet or the like to establish a collaboration session with an agent device on a PC, MAC, smartphone, Tablet, telephone or the like. In this particular example, one or more networks, such as the Internet, servers or the like allow the customer and agent devices to communicate via the collaboration session. In this particular example, an integrated system 40 includes each of the components for a system, such as shown in FIGS. 1 and 2. In this implementation, a customer and an agent communicate via the integrated system 40 in an RTC collaboration session.

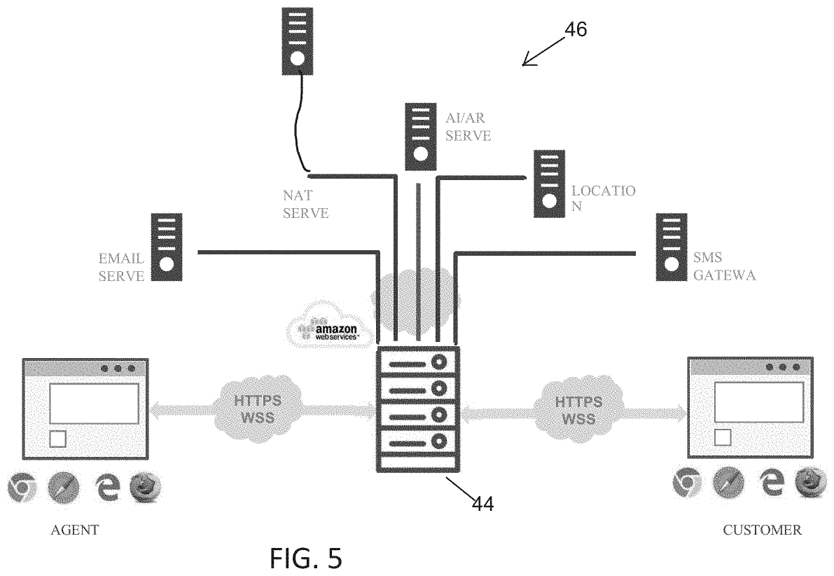

FIG. 5 is a schematic diagram showing an example distributed system architecture for a collaboration platform including one or more distributed components 46 that may interact with a base system 44 to provide an RTC collaboration session. In this particular embodiment, for example, the system architecture enables a customer on a mobile connected device, such as a Smartphone, or a Tablet or the like to establish a collaboration session with an agent device on a PC, MAC, smartphone, Tablet, telephone or the like. In this particular example, one or more networks, such as the Internet, servers or the like allow the customer and agent devices to communicate via the collaboration session. In this particular example, the distributed system includes a base system 44 including a plurality of the components for the overall system, such as shown in FIGS. 1 and 2, and further distributed components 46 that may be accessible via a network, such as the Internet, as shown in FIG. 5. In this implementation, a customer and an agent communicate via the distributed system in the RTC collaboration session. In this manner the distributed system may take advantage of third-party integration within the overall system via the network. In the example of FIG. 5, for example, the distributed components may include an email server, an SMS gateway, a NAT server, an AI/AR server, a location server, as well as any other number of components.

In one example, a User interface UI (e.g., Loookit UI) is coupled to a server (e.g., Loookit Server) and a database. A media server also provides media data, such as but not limited to streaming operations. The collaboration platform may also be scalable to different environments, such as shown operating systems including android, iOs, Apple, Firefox, Microsoft, and others, platforms such as PC, laptop, tablet, smartphone, and others, and delivery options, such as cloud service, integration APIs, on-premises servers, and others.

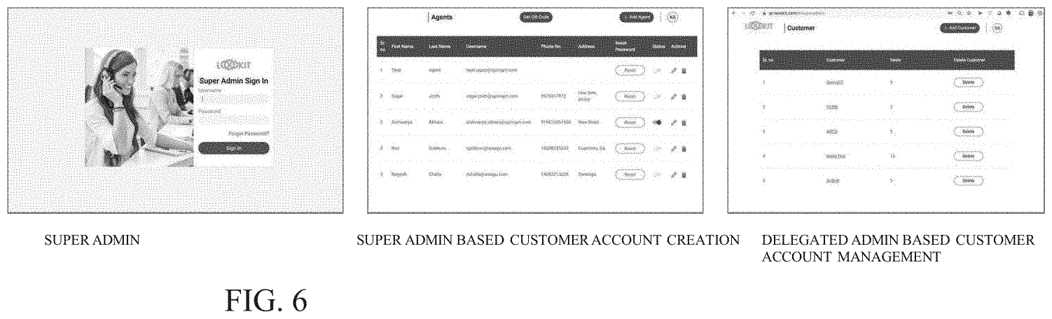

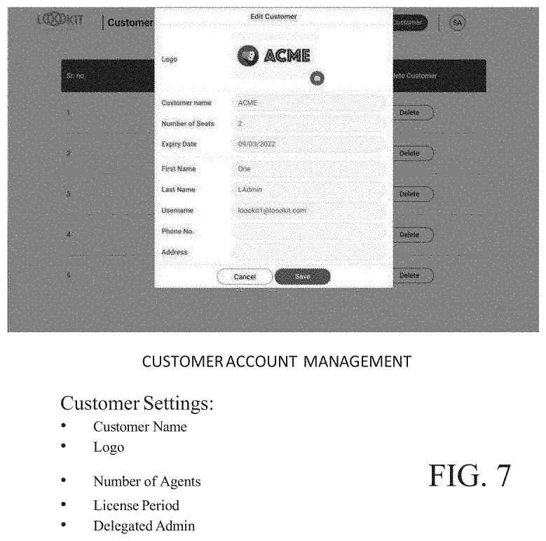

A collaboration platform backend may also be provided, such as to provide customer account creation and/or management. FIG. 6 shows an example collaboration platform backend including a sign in page, a customer account creation page and a delegated customer account management page. FIG. 7 further shows an example customer account management page that includes customer settings, such as customer name, logo, number of agents assigned to a customer, a license period and a delegated admin for the customer.

In another example embodiment, a communications session can be provided in which a collaboration session may be initiated such as via scanning a QR code with a camera of a customer device (e.g., smartphone). A link or other information included in the QR code directs the customer device to open a browser and direct the browser to a target site. A message on the site may direct the customer to wait for an available agent.

The system provides one or more possible agents with a link, such as through an email, SMS, text or the like, to enable them to join the communications session initiated by the customer. An available agent may then select the link to join the session with the customer. The agent can initiate the RTC communications session, such as an Audio/Video session. The customer device may prompt the customer to allow access to one or more features of the device (e.g., permission to access audio and camera).

Once the customer and agent are connected to the communications session, the customer and agent can participate with one another to resolve any questions or issues (8). Similarly, the Agent may be provided with the ability to restrict or allow access to a camera or other device features for the purpose of the communications session.

In another example, user screen displays information during the establishment and duration of an RTC communications session. In one particular embodiment, for example, the user directs his or her camera to a QR code and information included in the QR code can be used to direct a user device browser to a site associated with a communications session. A splash page or other page identifying the other party of the communications session may be displayed on the user device and the page may instruct the user to wait to be connected to an agent. In various implementations, for example, the user may be further prompted for any additional information that may help select an ideal agent (e.g., language preference).

When an agent has joined the call, the user device may allow the user to accept an incoming communications session (e.g., audio/video session), and the communications session is initiated. A video call may give the user options, for example, to direct the video to a front or back camera for the call. Annotation (arrows, text, drawings, etc.) or other tools may be used to identify a portion of the video capture to an agent (e.g., where the user is identifying a problem with a product). The user can also capture an image to be shared with the agent.

In one embodiment, a method of originating a communications/collaboration session between parties includes assigning a link to each person and embedding the link in one of the contact fields of a person's contact (e.g., a v-card). When a caller wishes to make a contact/call, they activate the link in the contact (e.g., v-card of an address book) and a browser opens that specified page represented by the link. The Callee gets a notification (message, social media notification, email, etc.) with a link (session page where the Caller is waiting) and responds. If busy, the Callee can send a message saying they will call back. Otherwise, they can send a calendar invite for a later time. Or if available, can accept the call by clicking the link in the notification. They are both in the session and can communicate with any or all of the available features (audio, video, screen share, white board etc.). In this example an end to end IP (using data) based communications method is provided without using the traditional telephony elements.

In yet another example embodiment of a collaboration platform system different example collaboration sessions may be enabled by the system for customer-initiated collaboration sessions. For example, local maps can be enabled to connect directly to one or more businesses, such as with a QR code or other smart trigger allowing a local map with actionable details to be downloaded to a user device. Sightseeing applications may allow a user to scan a smart trigger to connect to a visitation site, set a language, and engage with an agent that can provide detailed recommendations or further details about possible attractions, businesses, airport or other information, or the like. Smart triggers may help connect to services such as roadside assistance, auto repair, insurance information and documentation. For vacation and other rental properties, one or more smart codes located at the property may provide further information about one or more devices at the property, such as remote controls, appliances, entry codes, thermostats, Internet (wifi) connection, and the like.

During the RTC session, along with the Camera and/or microphone, information from any other sensor on the participants devices can be brought into the session. For example, using a Lidar feature in an iPhone 12, one can make measurements of any space and object(s) and share it in the session with other participants.

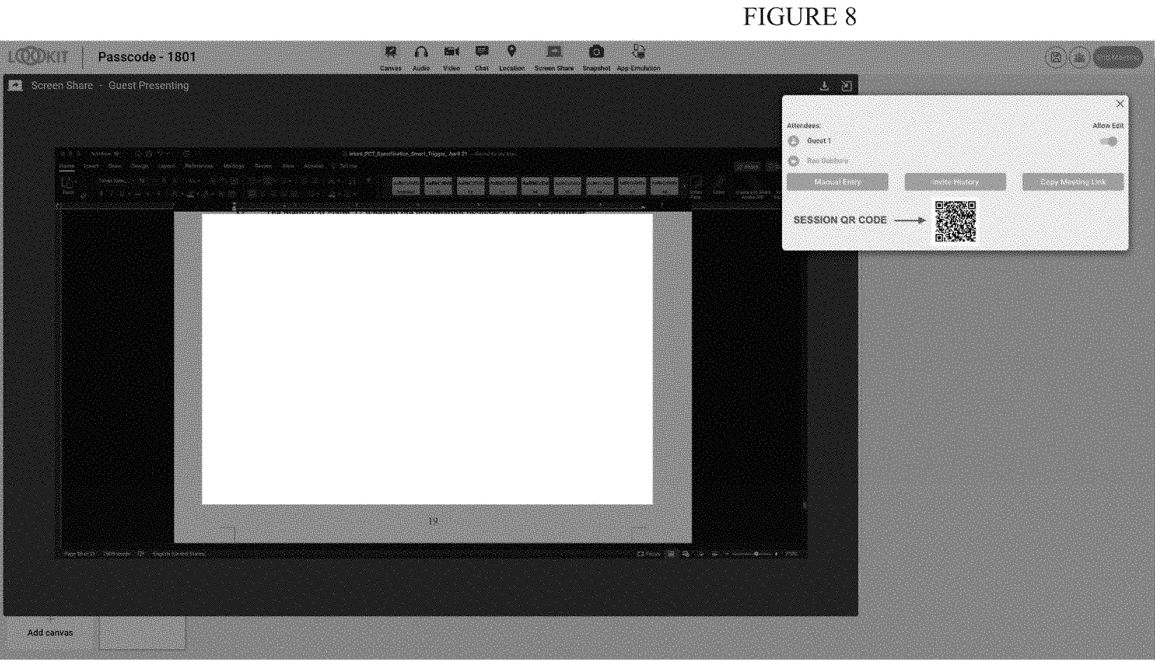

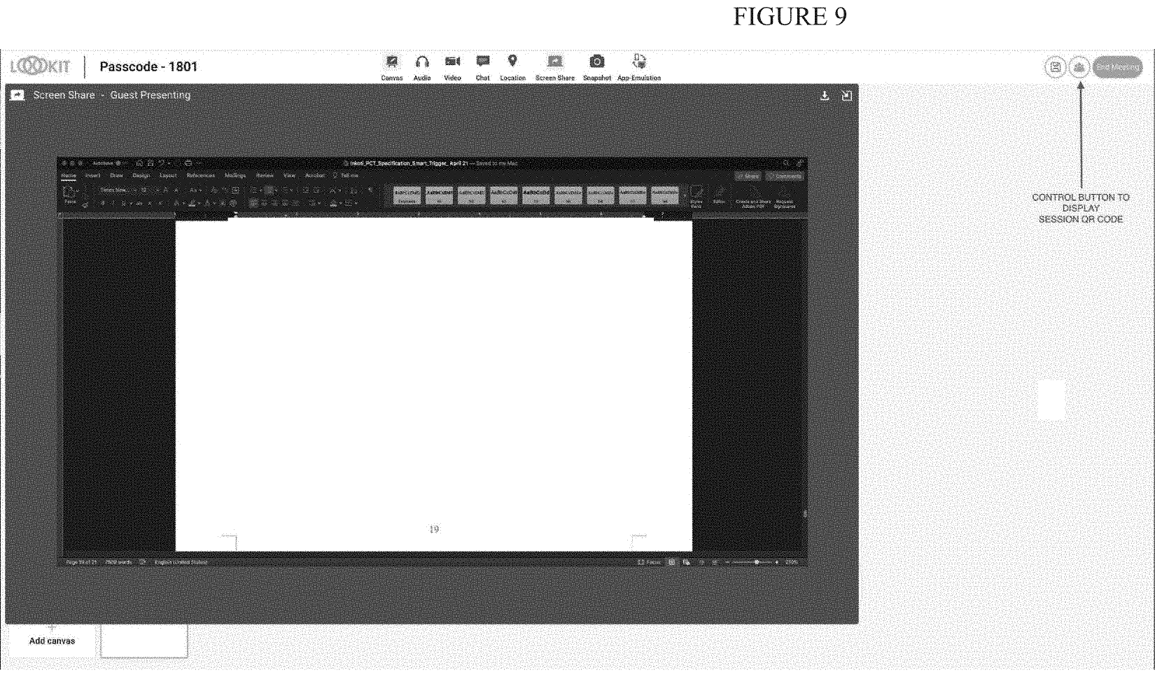

During the RTC session (or any other collaborative session whether or not initiated via a smart trigger) an additional device such as a smartphone, a tablet device or any device with a capability to interact with a “Smart Trigger” can be included in the ongoing session by any of the participants such as shown in FIGS. 8 and 9. For example, an additional device (e.g., Smartphone, tablet or other device) can scan a smart trigger, such as a “session QR Code” that is displayed automatically for each session as shown in FIG. 8 or can be displayed by a user action such as selecting an option (e.g., clicking on a control button (icon etc.)) as shown in FIG. 9. Other smart trigger mechanisms such as NFC tags, blue tooth, Air Drop as in the case of an iOS device or WIFI can also be used to bring additional devices into the communications/collaboration session. As an example, during a telehealth session that has been initiated on a PC, the patient can scan the session QR code using a smartphone to add it to the session/meeting and show the Doctor the wound on their foot. Other examples include devices that are more amenable to signature capture on documents. There are several other use cases where it is advantageous to bring in additional devices to include additional rich content in the session/meeting by simply using a Smart Trigger.

Where automated or simple interactions such as web chats fall short, a communications session may further enable escalation of a support engagement style to enable more rich features, such as those described herein.

Cookies from a web page can also make repeat visits more efficient by storing a history of interactions.

QR codes may include static or dynamic QR codes. Dynamic QR codes, for example may be able to be directed initially to one URL and then subsequently changed to a different URL (e.g., for a different property, for a different model/appliance in a product company portfolio) without having to be reprinted for different uses.

A backend can be adapted to conditionally redirect a communications session based up a QR code and subsequent information gathered during a browser-based exchange.

QR codes may be enabled for single use or for location locked use. A QR code for example, may be used in conjunction with device location information may be used to direct the communications session to a local agent. A QR code could also use time of day or other information to direct the session to one or more agents.

A QR code and a browser user agent can be used to tailor an experience for a user mobile device. For example, when a browser connects to a website, it may include a User-Agent field in an HTTP header. The coupled server can use this information to serve different web pages based upon the web browsers, the operating system (OS), the CPU and compatibility information. For example, a website could send mobile pages to mobile browsers, modern pages to modern browsers, etc.

Multiple sessions can be setup in parallel for the same QR code, such as QR codes at local maps near a subway station that connect to a business. There may be multiple billboards around the same subway station. In an Airbnb type scenario, multiple agents can respond to the multiple QR codes where each QR code could represent a particular property being managed.

Although implementations have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

1. A collaboration platform system comprising:
a user device comprising a camera and a browser; and
an agent device operatively coupled to communicate via a site,
wherein the collaboration platform is adapted to initiate a collaboration session between the user device and the agent device via information included in a smart trigger that provides a link to direct the user device browser to the site.

2. The collaboration platform system of claim 1 wherein the smart trigger comprises at least one of a QR code, a bar code and an NFC tag.

3. (canceled)

4. (canceled)

5. The collaboration platform system of claim 1 wherein the smart trigger comprises a QR code with static information.

6. The collaboration platform system of claim 5 wherein the static information comprises a support URL.

7. The collaboration platform system of claim 6 wherein the static information further comprises a physical address of a physical property.

8. The collaboration platform system of claim 1 wherein the smart trigger comprises a QR code with dynamic information.

9. The collaboration platform system of claim 8 wherein the dynamic information comprises a URL that allows redirection.

10. The collaboration platform system of claim 1 wherein the smart trigger comprises a QR code with augmented information.

11. The collaboration platform system of claim 10 wherein the augmented information comprises a support URL, a physical address and equipment information.

12. The collaboration platform system of claim 1 wherein the smart trigger device comprises a QR code and an NFC tag.

13. The collaboration platform system of claim 12 wherein the QR code and NFC tag combination restrict session initiation to a predetermined location.

14. The collaboration platform system of claim 1 wherein the QR code comprises binary data.

15. The collaboration platform system of claim 1 wherein the collaboration session comprises launching and setting up a browser-based collaboration session.

16. The collaboration platform system of claim 1 wherein the collaboration session comprises an incident reporting scenario where an incident is identified via the smart trigger.

17. (canceled)

18. (canceled)

19. The collaboration platform system of claim 1 wherein the smart trigger comprises pre-defined content adapted to be communicated to the agent device.

20. (canceled)

21. (canceled)

22. The collaboration platform system of claim 1 wherein the smart trigger initiated collaboration session could start via one or more of the following:
immediately with a customer support agent; and
first with a chat bot escalated to a human support agent.

23. The collaboration platform system of claim 1 wherein the collaboration session comprises one or more of the group comprising: an immediate session, a scheduled session, a simple collaboration session, a rich collaboration session, a clear collaboration session, and an encoded collaboration session.

24. (canceled)

25. (canceled)

26. The collaboration platform system of claim 1 wherein the browser is part of an application on the user device.

27. A method of providing a collaboration session comprising:
scanning a smart trigger with a user device to receive information including at least one link associated with the smart trigger;
using the link via the user device to access a user interface on a web page;
initiating a communications session with at least one agent based on the information.

28-39. (canceled)

40. A collaboration platform system comprising:
a first communication device;
a second communication device comprising a camera and a browser; and
a system adapted to be communicatively coupled to the first communication device in a collaborative session, the system further adapted to add the second communication device to the collaborative session via information in a smart trigger that provides a link to direct the second communication device browser to the site.

41-59. (canceled)
